(19) United States
(12) Patent Application Publication
(10) Pub. No.: US 2004/0142662 A1
(43) Pub. Date: Jul. 22, 2004

(54) Remote change of status signal device

(76) Inventor: Thomas Ehrenberg, Putney, VT (US)

Correspondence Address: KEVIN ELLICOTT, ESQ., 1 SCALE AVE., SUITE 112, RUTLAND, VT, 05701, US

(21) Appl. No.: 10/347,959

(22) Filed: Jan. 21, 2003

(51) Int. Cl. H04B 7/00; H04H 1/00; H04B 1/00; H04M 1/00; H01S 4/00

(52) U.S. Cl. 455/66.1; 455/899

(57) ABSTRACT

A remote change of status signal device comprising a central unit, a power supply, at least one sensor for detecting a change of status in that which is being monitored and sending a signal to a transmitter, the transmitter being electrically connected to the sensor and power supply for transmitting a signal in response to the change of status, a signal broadcast means electrically connected to the transmitter for broadcasting the signal from the transmitter and a portable remote receiving and signaling device for receiving the broadcast signal and alerting the user of the device to the change of status.

### CROSS REFERENCE TO OTHER APPLICATIONS

This is the first submission of an application for this article of manufacture. There are no other applications, provisional or non provisional.

### FEDERALLY SPONSORED RESEARCH AND DEVELOPMENT

There are no federally sponsored or funded research or development projects or undertakings in any way associated with the instant invention.

### BACKGROUND OF THE INVENTION

1. Field of the Invention

The instant invention relates to that field of devices consisting of articles of manufacture known as signaling devices. Specifically, the instant invention is a signaling device which remotely informs the user of a change of status in that which is being monitored.

2. Background Information

The prior art known to the Inventor discloses that change of status devices are fairly well known in the art. Perhaps the simplest example of such a change of status device would be the stylized metal flag often attached to a mailbox. When the sender of mail in a residential setting wishes to inform the postal service mail carrier that there is mail in the box which needs to be picked up, the sender simply adjusts the flag into an upright position, that being the convention currently known to the mail carrier as signaling the presence of mail awaiting pick up. Upon retrieving that mail form the box, the carrier usually replaces the flag into its original position, thus notifying the sender that the mail has been picked up.

It is also relatively well known now that information may be transmitted over a distance. The phone, telegraph, and satellite broadcast being but a few means for transferring information over a distance.

Unfortunately, nowhere in the art has there been an attempt to provide for a remote change of status device which would meet the particular needs of individuals, families and caretakers who need to be immediately informed of a change of the status of, for example, a dependent person afflicted with one form or another of infirmity, when those individuals, families and caretakers are at a distance from the dependent person.

Perhaps the best example of such un-met need is in the area of caring for those beset with various cognitive impairments such as senility (Alzheimer's disease). Those charged with the care of cognitively impaired individuals often find themselves inextricably tied to the physical location where the impaired individual spends the majority of his or her time. For example, an Alzheimer patient who spends the majority of his or her time bed-ridden often forces the caretaker to spend the majority of the caretaker's time at the bedside, or in close proximity thereto. Those familiar with the care of such individuals will immediately recognize the reason for such close proximity: an Alzheimer patient left unattended may very well get out of that bed and wander nearly anywhere. Unattended Alzheimer patients have been known to leave a bed, wander out a front door, and become lost in the woods (a scenario which has been know to culminate in the death of the patient from exposure).

Though attempts have been made to fabricate systems and devices which would inform caretakers of a change of status in the dependent who is being monitored, these systems and devices have been subject to the same limitations. The principal limitation has been the ever-present requirement for continued close proximity between the dependent and the caregiver. For example, it is possible to place a pressure sensitive device on or under a dependent's mattress such that when the dependent's weight is removed from the pressure pad, an alarm is sounded. However, systems and devices to date rely upon sensors such as pressure sensitive devices which are “hard wired” to status change notification components such as bells and lights. These noise produced by these systems are frequently the source of significant distraction and discomfort to both the dependent and others. In order to inform the care taker of the change of status, it has been required that the care taker be in close enough proximity to the bell or light so as to become immediately aware of that change of status. In the alternative, efforts to provide for status change notification components have to date required that they too be in close proximity to a device used to register the change of status. Even when not hard wired together, the status change registration device or sensor and status change notification device have been severely limited to being separated by only a short distance.

As a result, caretakers often find themselves prisoners of the residence wherein the dependent is physically located. This in turn often leads to feelings of resentment and the potential for reduced vigilance over the extended periods of time spent caretaking.

Additional examples of uses for the instant invention include monitoring a baby or small child, notification of arrivals (or intrusion) to a home, notification of the arrival of mail, and so on.

Another example of the utility of the instant invention for example, might be found in the situation of someone expecting repair personnel or a delivery to the house, and yet wanting to go work in the garden. Or, perhaps, a parent awaiting the return of her child from school and wanting to have a cup of tea with the neighbor, or even going off to the corner store. In short, in any situation where the situation does require monitoring, and where the user will be close enough to receive the signal (and, ipso facto, thus close enough to respond in good time), and where the user wants a relatively private signal of the change of status rather than the sounding of an al the instant invention fills a need not provided for heretofore.

### SUMMARY OF THE INVENTION

The instant invention is a remote change of status device which may be configured in a wide variety of ways, and incorporate a wide variety of sensors/sensing components for purposes of monitoring a change of status, from a remote location.

For example, unlike the traditional devices used to monitor any change of status of a dependent, the instant invention incorporates a component which allows the caretaker to remove him or herself from close proximity to the dependent and still become immediately aware of any change of status of which is being monitored.

Continuing with the aforementioned example, the remote change of status device may be configured to incorporate a pressure sensitive pad on the floor next to the bed of the dependent such that any pressure placed upon the pad (e.g., stepping out of bed) is immediately registered and a signal is sent to a remote receiver in the possession of the caretaker, thus providing nearly instantaneous notification of the change of status (e.g., the movement of the dependent from being on the bed to placing his or her feet upon the pressure sensitive pad on the floor). The caretaker may then respond by returning from a remote location and visually inspect the status of the dependent, or even contact another caretaker who may be in closer proximity to the dependent at that moment so that the alternate caretaker may inspect the status of the dependent.

While the remote change of status device has heretofore been described in its application to a caretaker/dependent situation, the inventor believes that a wide variety of change of status situations could be handled equally well by this system by merely altering the components. For example, a status-monitoring device such as a microphone could be placed in the room of an infant. That monitoring device would be incorporated into the instant invention such that stimulus is provided to the microphone (e.g., the sound of a baby crying), the change of status would be registered by the system and the portable remote receiver/signaler device (e.g., “beeper”) would provide notification of the status change.

Another example would be sensing of visitors or intruders and notification thereof. Such a configuration could easily be accomplished by incorporating a sensor on an entry portal (door or window) which, when triggered, would provide notification of same to a remote location.

The object of the instant invention, therefore, is to provide for a remote change of status system capable of remotely reporting that a change of status has taken place.

This objective is accomplished by constructing a componential system having at least one sensor/sensor, the sensor being connected to a transmitter capable of transmitting a signal to a portable remote receiver/signaler, the remote receiver/signaler being capable of notifying the user that a change of status has taken place.

### A DESCRIPTION OF THE DRAWINGS

FIG. 1 is a perspective view of the completed device.

FIG. 2 is a schematic diagram detailing a first embodiment of the instant invention.

FIG. 3 is a schematic diagram detailing a second embodiment of the instant invention.

FIG. 4 is a schematic view of an alternate embodiment of the instant invention.

FIG. 5 is a schematic diagram detailing a third embodiment of the instant invention.

FIG. 6 is a schematic diagram detailing a fourth embodiment of the instant invention.

### A DESCRIPTION OF THE PREFERRED EMBODIMENT

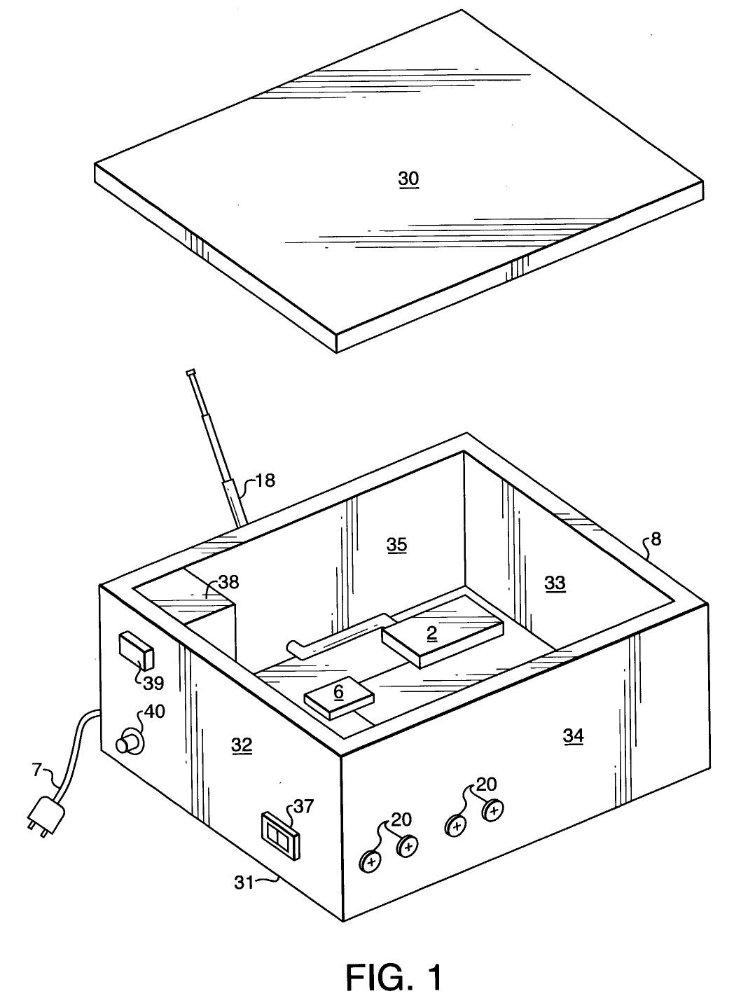

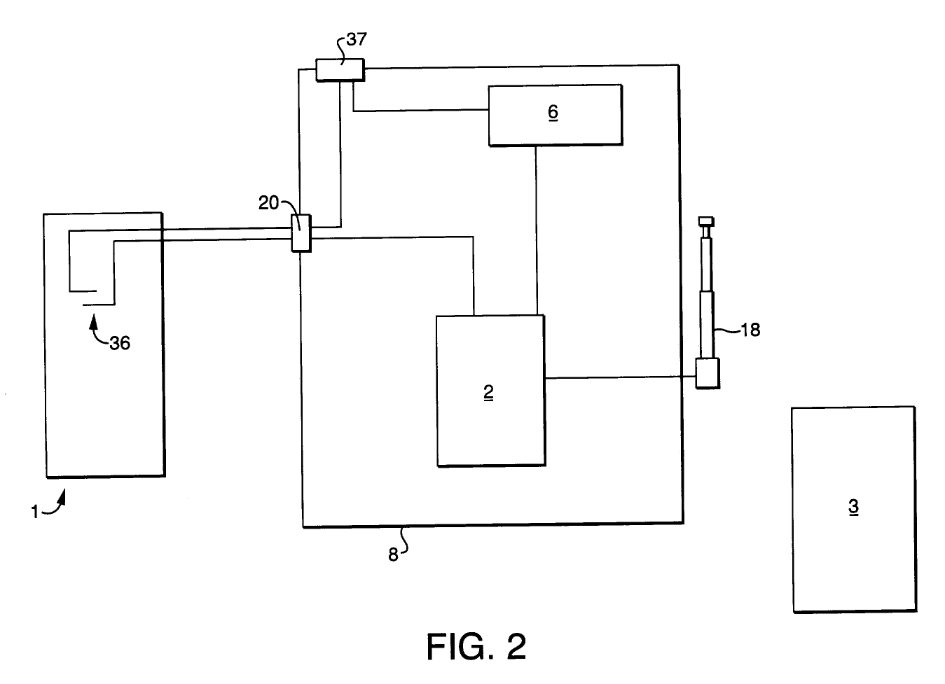

As per FIGS. 1 and 2, a remote change of status device includes, preferably, a sensor (1) capable of activating a transmitter (2) to broadcast a signal to a portable remote receiving and signaling device (3), hereinafter “receiver/signaler”. In the preferred embodiment, the transmitter (2) is mounted within a central unit (8) and is capable of broadcasting the signal over a distance to the portable remote receiver/signaler (3). A power supply (6) to energize the device may easily be provided for in a wide variety of ways.

In its simplest form, as discussed in the first embodiment, the sensor (1) is adapted to communicate with and actuate the transmitter (2). The transmitter, upon having been actuated/activated by the sensor then produces and broadcasts a signal that is capable of being received by the portable remote receiver/signaler (3). Finally, the remote receiver/signaler emits a signal in a form that is registered by human senses (e.g., a beeping tone).

The power supply may be battery power or other power such as adapted grid power. So long as the power supply is compatible and capable of activating the transmitter, it will function as intended. This may easily be accomplished by using, for example, 12-Volt direct current as the power supply. However, a transformer/converter (so-called “cube”) unit may be incorporated to utilize 120-Volt Alternating Current (provided by a standard electrical outlet such as that found in most homes, through a standard two-bladed plug (7)), which is then transformed to 12-Volt Direct Current, which provides current to the central unit. It should be understood that battery and AC power supplies could be combined in a chargeable and or backup configuration including a trickle charger (38) to provide battery backup for the system in the event of a power failure; in addition, grid power can provide a trickle charge to keep the system battery power fully charged. For purposes of discussion, however, it will be assumed that the power supply is 12-Volt battery.

While obviously the central unit (8) could take a wide variety of forms, for purposes of simple understanding it will be described as essentially a box-like body having walls, the walls defining a hollow interior space. For purposes of discussion, in the preferred embodiment the central unit may be a generally rectangular box-like body having a top wall (30), bottom wall (31), front wall (32), rear wall (33), right side wall (34) and left side wall (35). As would be expected, the top wall is opposite the bottom wall and adjacent to and perpendicular to the right side wall, left side wall, front wall and back wall. Furthermore, as would be expected, when fully assembled the front wall is opposite the rear wall and perpendicular to the right sidewall, the left sidewall, the top wall and the bottom wall. Again, the central unit is simply a case or enclosure which could take any number of forms, not necessarily box-like in shape. And could be fabricated in a wide variety of ways including from metal, injection molded plastic, or any other suitable means.

While the power supply may be external to the central unit, for purposes of discussion it will be assumed in the preferred embodiment that the central unit is capable of being disassembled or opened, and that the power supply (battery in this example) is located within the hollow interior of the central unit, in a suitably easily accessible portion of the central unit.

As per FIG. 2, the first embodiment of the instant invention also includes at least one sensor input terminal (20). The sensor input terminal allows the sensor to be directly and electrically connected to both the power supply (6) and the transmitter (2). This may be accomplished with any of the common electrical connections such as a pair of screw terminals, jacks, etc.

In the preferred embodiment, the sensor (1) is a conventional pressure sensitive pad. In such a pressure sensitive pad, the pad includes a first electrical contact and a second electrical contact. In such a pressure sensitive pad, the first contact and second contact are spread apart from one another. Applying pressure to the surface of the pad results in first contact and the second contact touching one another. The application of pressure to the pad, in this case, is the “change of status”, with the contacts functioning essentially as a sensor switch (36).

It is the coming together of these two contacts that permits the flow of electricity from the power supply (6) to the transmitter (2). When electricity is supplied to the transmitter, it broadcasts a signal that may be received by the signaler/receiver (3). Again, while a pressure sensitive pad is referenced here as the “sensor”, the instant invention is clearly not limited to a pressure sensitive pad as the sensor. Nearly any sensor that will register a change of status may be substituted in the pad's place. A non-limiting example might be a switch on a door or window which is opened when the door or window is moved so that the “change of status” (the movement of the door or window) is registered and a signal is thereby sent to the central unit for processing.

In the preferred embodiment, the transmitter broadcasts a signal (e.g. carrier frequency of 28.5 MHz amplitude modulation radio signal) appropriate to be received by the receiver/signaler, or “beeper”. In this example, the signal is a short duration signal (e.g. 6 seconds) of sufficient strength (e.g. 5 Watts) to be received by the receiver/signaler within a range of approximately 1-mile.

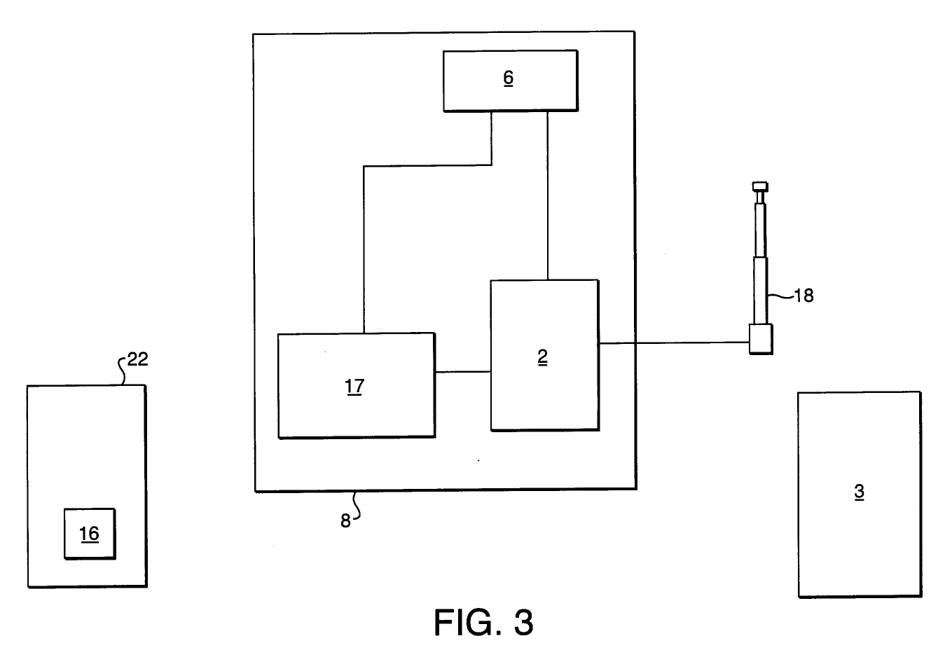

In a second embodiment of the instant invention, as per FIG. 3, the sensor is not directly connected or “hard wired” to the central unit via an input terminal. Instead, a remote sensor (22) is provided with its own sensor power supply (16) in order to activate the transmitter (2) with minimal power (voltage) being required of the remote sensor. This has the distinct advantage of allowing the remote sensor to “stand alone” without the necessity of connecting it to either, for example, household current or the central unit, thus allowing for both portability and for the ability to place the remote sensor in a greater variety of locations. The sensor power supply in the second embodiment is a battery.

In the first embodiment of the instant invention, the sensor (1) was electrically connected (wired) to the central unit power supply (6) such that when the sensor was activated (pressure was applied, closing the contacts of the switch), electrical current could flow from the power supply, through the closed sensor switch, and to the transmitter (2), activating the transmitter to broadcast a signal to the receiver/signaler (3).

In the second embodiment, there is no direct electrical connection between the remote sensor (22) and the central unit (8). Instead, upon being activated, the remote sensor (22) produces a signal capable of being transmitted over a distance without intervening electrical wires. Therefore, the remote sensor (22) needs only so much electrical current as is required to produce and broadcast this signal. This may be most readily understood in the case of a remote sensor that is constructed and configured to emit a radio signal at a certain frequency. The signal need only be strong enough to reach the central unit and thus be received by a signal receiver having a switch (17), located within the central unit (8). The signal receiver having a switch is electrically connected to both the power supply (6) and the transmitter (2). Clearly, the signal receiver having a switch must be tuned to receive the signal generated by the remote sensor (22), for example, tuned to receive a 290 MHz radio signal where the remote sensor produces a 290 MHz radio signal. Upon receipt of the radio signal, the signal receiver having a switch is activated by said signal, and the switch is closed, resulting in a completed circuit, and permitting the flow of electrical current from the power supply (6) to the transmitter. As with the first embodiment, once the electrical current activates the transmitter, a signal is broadcast to the receiver/signaler (3). The signal receiver having a switch will present no difficulty to the routineer in the art as such a radio signal operated relay or switch or solenoid is very well known within the art (e.g., a car door lock operating by remote key-chain switch).

Therefore, it should be clear that in order for the device to function as intended by the inventor, the remote sensor must be able to function as an independent change of status switch which, when closed, sends a signal to the signal receiver having a switch (17). Remote sensors capable of producing and transmitting a signal in this fashion are extremely well known and are available “off the shelf”, for example, the 63-874 available from Radio Shack, the Optex Wireless 1000 system and Optex Smarthome 7510.

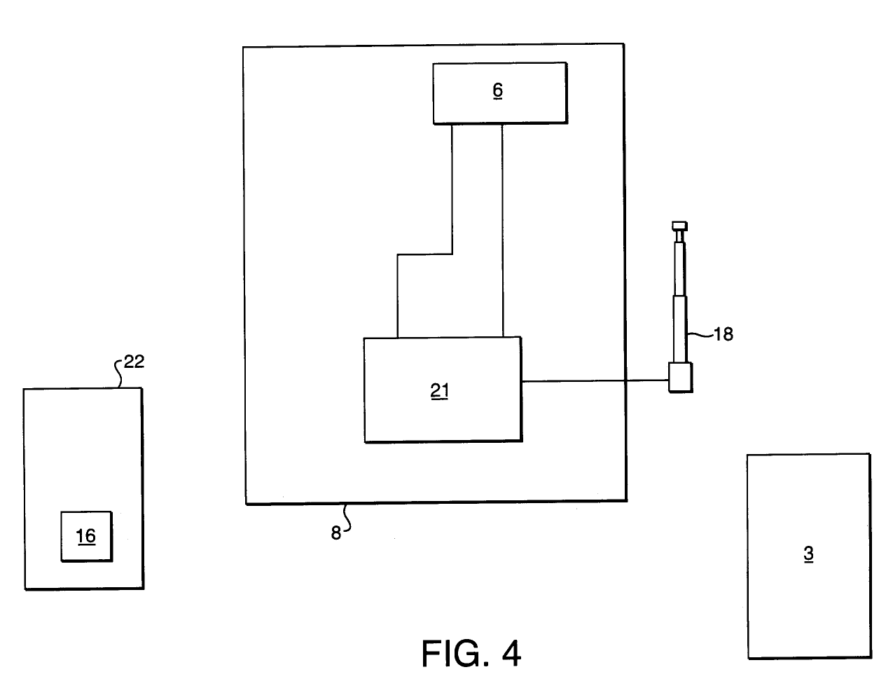

As per FIG. 4, it may be just as desirable to simply include within the central unit (8) a signal amplifier (21) capable of receiving the signal sent by the remote sensor (22) and amplifying it sufficiently so that the signal may be used to activate the receiver/signaler. Such an arrangement would take the place of and the remove the necessity for the signal receiver having a switch (17) and the transmitter (2). Signal amplification is extremely well known in the art, and the precise circuitry utilized is unimportant so long as the signal produced by the remote sensor is received by the signal amplifier and sufficiently amplified such that it may be received by the receiver/signaler and activate said receiver signaler, thus informing the user of the change of status.

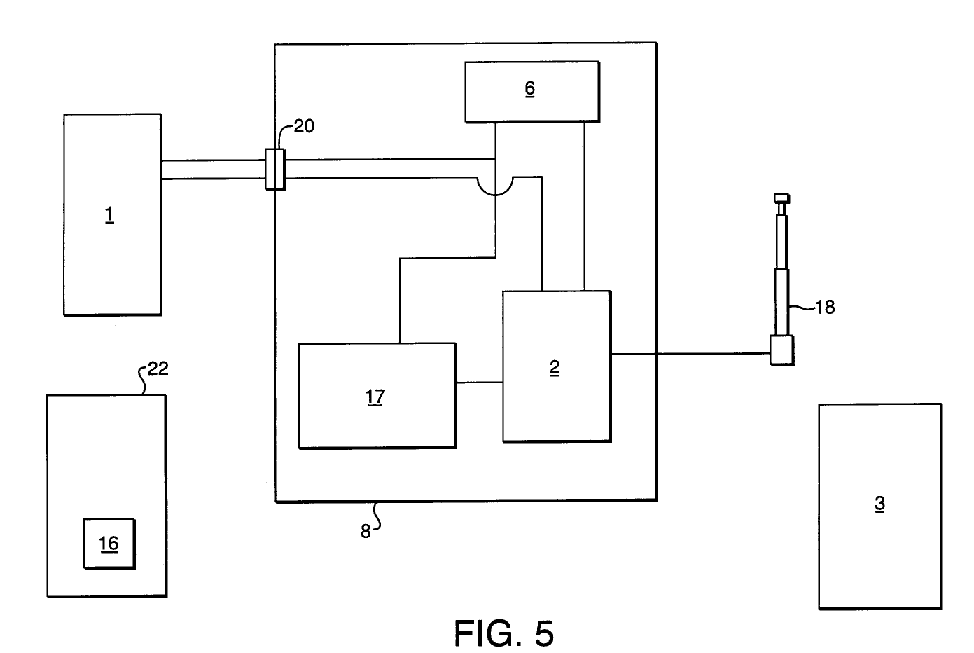

As per FIG. 5, in a third embodiment of the instant invention, the central unit (8) is configured to utilize a hard-wired sensor and/or a remote sensor. That is, the third embodiment is in all ways identical to the first embodiment, however, it further includes the necessary equipment to utilize one or more remote sensors as well, if so desired.

The third embodiment is essentially a combination of both the first and second embodiments. The inventor is aware of no other device which combines, in this novel fashion, both the ability to broadcast a signal to a “beeper” unit in response to the change of status in either a hard wired sensor and/or a remote sensor. This embodiment thus gives the user the options of the advantages of “hard wired” sensors (primarily permanence and reliability) and of remote sensors (primarily portability and flexibility).

Those skilled in the art will understand that it is possible to configure the electrical circuitry (wiring) of the device to provide electrical current both to the sensor (1), which is electrically connected to the power supply, and to the transmitter (2). As with the first embodiment, in the event that the sensor (1) is triggered (the relay or switch closed), electrical current will be fed to the transmitter (2) so that the transmitter will be activated and thereby broadcast a signal to the receiver/signaler (3). Also, as with the second embodiment, in the event that the remote sensor (22) is triggered, the remote sensor will broadcast a signal to the signal receiver having a switch (17), the signal receiver having a switch will be activated and permit electrical current from the power supply to be supplied to the transmitter (2) so that the transmitter will be activated and thereby broadcast a signal to the receiver/signaler (3).

The precise wiring arrangements of the various components (power supply, signal receiver having a switch, transmitter, sensor, signal amplifier, etc.) are unimportant and clearly may be accomplished in a multitude of ways in order to “electrically connect” them to one another. Whether directly hard wired using single strands of insulated electrically conductive wire, or electrically connected to one another via a printed circuit board, the device will function as intended. That is, a change of status at a sensor will cause a transmitter to broadcast a signal which will be received remotely, at a distance, by a receiver/signaler which will thereby be activated to produce a signal capable of being felt or seen or heard by appropriate human senses.

Also, as per FIGS. 1 and 2, it may be useful to include a power on/power off switch (37) that will activate and deactivate the entire device. Such a power switch may easily be configured to interrupt electrical current from reaching the power supply, or may be configured to interrupt electrical current from reaching the sensor (1) and/or receiver having a switch (17). Each embodiment and example of the instant invention may include such a power switch. Each embodiment may further include an indicator lamp (39) for purposes of showing that the device has operative power. Furthermore, it may be desirable in any of the embodiments herein disclosed to include a test switch (40) for purposes of testing to see if the instant invention is functioning and/or trigger (activate) the beeper.

Obviously, the third embodiment may be modified to include the signal amplification set forth in the second embodiment, as well.

Whether the first, second, or third embodiments of the instant invention are chosen, the device should also include an element over which the transmitter signal may be broadcast, such as a signal broadcast means (18). Such signal broadcast means makes possible the broadcast of the signal produced by the transmitter (2) and may be as simple as a radio antenna. Furthermore, it should be understood that while the transmitter (2) may be easily configured to broadcast a radio wave over the signal broadcast means (18), it could just as satisfactorily generate practically any suitable signal such as, for example, radio waves carrying binary code, or microwaves. So long as the signal generated by the transmitter can be broadcast distantly (preferably up to a mile) to a remote receiver/signaler, the device will function as intended.

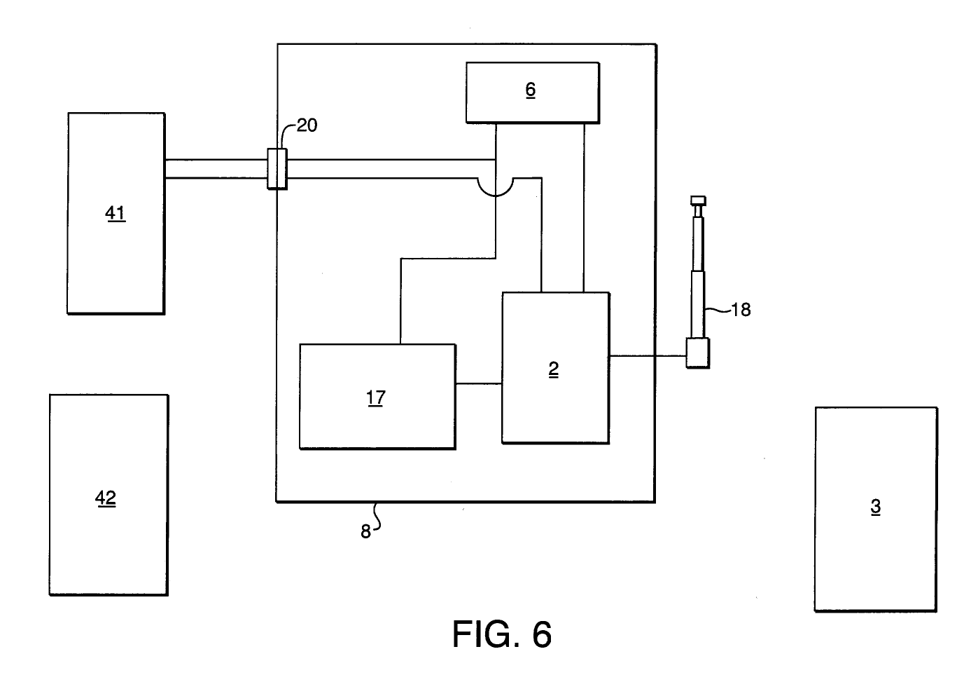

In a fourth embodiment, as per FIG. 6, the invention can be co-configured with existing alarm systems. These systems may be either already installed or of the sort available from numerous producers. Examples of such systems include the Radio Shack 49-451 and the SmartHome 7500 series. In this embodiment, the invention is connected to the alarm system such that, when there is an intrusion, excessive smoke, sound of baby crying, motion, etc., and the system is triggered, in addition to or instead of whatever alarm is actuated the instant invention is actuated and a signal is transmitted through the central unit to the receiving beeper unit.

In this embodiment, a sensor input to the central unit of the instant invention is connected to an output of the alarm system. This embodiment would thus greatly increase the utility and applications of both the alarm system and the instant invention. For purposes of this embodiment, it would not matter whether the alarm system were portable or fixed, residential or commercial, had conventional wiring or microprocessor supervision, were battery or grid powered, etc. Virtually all alarm systems give the user the ability to use an output from the alarm system, either directly or through the use of a relay, to be an input to the instant invention and thus give the alarm system the capability, through this invention, of operating a “beeper”.

The advantage to the consumer, in the form of both simplicity of installation and cost savings, of this embodiment is obvious, as the sensors are already available and on line if the place in question is equipped with an alarm system, making the purchase of either remote (second embodiment) or hard wired (first embodiment) sensors unnecessary. In effect, this embodiment utilizes the already existing alarm system as a substitute for the “sensor” described in the first and second embodiments. The alarm system could be a hardwired alarm system (41) substituting for the sensor of the first embodiment, or could be a remote alarm system (42) substituting for the sensor second embodiment. Activation of the sensor (or alarm system) actuates the receiver having a switch (17) and/or the transmitter (2) to produce the signal which is in turn received by the signaler/receiver (beeper) (3).

In all embodiments of the invention thus far described, the signal sent over a distance by the transmitter is then received by the portable remote receiver/signaler (3) and converted into a form that may be detected by human senses. For example, the remote receiver/signaler could be a “beeper” or “pager” which, upon receiving the signal from the transmitter, would produce an audible tone capable of being heard by the user of the device. While a “beeping” signal, musical tone, etc. is the simplest and most common signal given off by receiver/signalers, any signal recognized by mammalian senses (such as hearing, sight or even tactile impressions produced by temperature change, vibration and the like) would work equally well. These “beeper” or “pager” style receiver/signalers are extremely well known throughout the art, being little more than a receiver capable of receiving a signal from the transmitter (2) which, once activated, in turn produces a signal capable of being recognized by human senses. Most often the transmitter signal is a radio wave, and the receiver/signaler is powered by a self-contained power supply (e.g., a battery) and configured to receive said radio wave. Upon receipt of said radio wave, a switch within the receiver/signaler is activated which in turn provides current to a tone generator which may be heard as a “beep” when the tone generator is activated.

It should be immediately recognized by those familiar with the art that the instant device departs from and significantly improves the prior art. It has long been a problem with remote sensors that they required fairly significant electrical current input in order to activate a transmitter which would then transmit a signal which could be remotely received and acted upon. By configuring the instant invention as disclosed above, it is now possible for the sensor to ultimately signal the receiver/signaler with minimal power requirements, thus allowing notification of the status change even at a significant distance.

Furthermore, no telephone or telephone line is required in order for the instant invention to operate, thereby making the device useful in many locations where phones or even cellular phone service is not readily available. The relatively low electrical voltage (current) available to power the remote sensor would never have been sufficient to signal the receiver/signaler at a sufficient distance in the prior art. However, by including the signal receiver having a switch (17), which is capable of being activated by the signal emitted by the remote sensor, the signal receiver having a switch in turn providing a greater amount of electrical current flow to pass from the power supply, through the signal receiver having a switch, and to the transmitter and be used by that transmitter to activate the broadcasting of a signal capable of being received by the receiver/signaler, the instant invention finally makes possible an essentially “wireless” sensor capable of ultimately producing a signal at a receiver/signaler which may inform the user of a change of status remotely at a distance accommodating the need to be removed from the site of the change of status.

I claim:

1. A remote change of status signal device comprising;
A. a central unit,
I. the central unit having a hollow interior space,
II. the central unit having at least one sensor input terminal,
B. a power supply,
I. the power supply being located within the central unit hollow interior space,
C. a sensor,
I. the sensor being electrically connected to the power supply, through the sensor input terminal,
II. the sensor being located remotely from the central unit,
D. a transmitter for transmitting a signal,
I. the transmitter being electrically connected to the power supply and to the sensor through the sensor input terminal,
II. the transmitter being located within the central unit hollow interior space,
E. a signal broadcast means connected to the transmitter,
F. a portable remote receiving and signaling device for receiving the signal transmitted by the transmitter and then signaling to indicate a change of status has taken place at the sensor,
I. the portable remote receiving and signaling device being located remotely from the central unit

2. A remote change of status signal device according to claim 1 further comprising;
A. The sensor being an alarm system

3. A remote change of status signal device according to claim 1 further comprising;
A. a power switch located on the central unit,
I. the power switch being electrically connected to the power supply such that the power switch may interrupt electrical current.

4. A remote change of status signal device according to claim 1 further comprising;
A. a test switch located on the central unit.

5. A remote change of status signal device according to claim 1 further comprising;
A. an indicator lamp,
I. the indicator lamp being located on the central unit.

6. A remote change of status signal device according to claim 1 further comprising;
A. a signal producing and transmitting remote sensor,
I. the remote sensor being located remotely from the central unit,
II. the remote sensor having a sensor power supply,
B. a signal receiver having a switch,
I. the signal receiver having a switch being electrically connected to the power supply,
II. the signal receiver having a switch being located within the central unit hollow interior space,
III. the signal receiver having a switch being electrically connected to the transmitter

7. A remote change of status signal device according to claim 6 further comprising;
A. a power switch located on the central unit,
I. the power switch being electrically connected to the power supply such that the power switch may interrupt electrical current.

8. A remote change of status signal device according to claim 6 farther comprising;
A. a test switch located on the central unit.

9. A remote change of status signal device according to claim 6 further comprising;
A. an indicator lamp,
I. the indicator lamp being located on the central unit.

10. A remote change of status signal device according to claim 1 further comprising;
A. the power supply being a battery.

11. A remote change of status signal device according to claim 1 further comprising;
A. the power supply being a transformer,
I. the transformer being electrically connected to an electrical outlet.

12. A remote change of status signal device according to claim 1 further comprising;
A. the power supply being a battery,
B. a trickle charger,
I. the trickle charger being electrically connected to an electrical outlet,
II. the trickle charger being electrically connected to the battery.

13. A remote change of status signal device according to claim 1 further comprising;
A. the power supply being a transformer,
I. the transformer being electrically connected to an electrical outlet,
B. a trickle charger
I. the trickle charger being electrically connected to the transformer,
C. a battery
I. the battery being electrically connected to the trickle charger.

14. A remote change of status signal device according to claim 1 further comprising;
A. the sensor being a pressure sensitive pad.

15. A remote change of status signal device comprising;
A. a central unit,
I. the central unit having a hollow interior space,
B. a power supply,
I. the power supply being located within the central unit hollow interior space,
C. a signal producing and transmitting remote sensor,
I. the remote sensor being located remotely from the central unit,
II. the remote sensor having a sensor power supply,
D. a signal receiver having a switch,
I. the signal receiver having a switch being electrically connected to the power supply,
II. the signal receiver having a switch being located within the central unit hollow interior space,
E. a transmitter for transmitting a signal,
I. the transmitter being electrically connected to the power supply and the signal receiver having a switch,
II. the transmitter being located within the central unit hollow interior space,
F. signal broadcast means connected to the transmitter,
G. a portable remote receiving and signaling device for receiving the signal transmitted by the transmitter and then signaling to indicate a change of status has taken place at the sensor,
I. the portable remote receiving and signaling device being located remotely from the central unit

16. A remote change of status signal device according to claim 15 further comprising;
A. a power switch located on the central unit,
I. the power switch being electrically connected to the power supply such that the power switch may interrupt electrical current.

17. A remote change of status signal device according to claim 15 further comprising;
A. a test switch located on the central unit.

18. A remote change of status signal device according to claim 15 further comprising;
A. an indicator lamp,
I. the indicator lamp being located on the central unit.

19. A remote change of status signal device comprising;
A. a central unit,
I. the central unit having a hollow interior space,
B. a power supply,
I. the power supply being located within the central unit hollow interior space,
C. a signal producing and transmitting remote sensor,
I. the remote sensor being located remotely from the central unit,
II. the remote sensor having a sensor power supply,
D. a signal amplifier for receiving the signal produced by the remote sensor and amplifying said signal,
I. the signal amplifier being electrically connected to the power supply,
II. the signal amplifier being located within the central unit hollow interior space,
E. signal broadcast means connected to the signal amplifier,
F. a portable remote receiving and signaling device for receiving the signal amplified by the signal amplifier and then signaling to indicate a change of status has taken place at the sensor,
I. the portable remote receiving and signaling device being located remotely from the central unit

20. A remote change of status signal device according to claim 19 further comprising;
A. a power switch located on the central unit,
I. the power switch being electrically connected to the power supply such that the power switch may interrupt electrical current.
II. a test switch located on the central unit.
III. an indicator lamp,
a. the indicator lamp being located on the central unit.
